(19) United States
(12) Patent Application Publication
(10) Pub. No.: US 2015/0148199 A1
(43) Pub. Date: May 28, 2015

(54) Handheld Extremity Inflexibility Treatment Device

(71) Applicants: Roger Nicholas Strickland, Wilmington, DE (US); Joseph Michael Dawson, III, Wilmington, DE (US)

(72) Inventors: Roger Nicholas Strickland, Wilmington, DE (US); Joseph Michael Dawson, III, Wilmington, DE (US)

(21) Appl. No.: 14/092,074

(22) Filed: Nov. 27, 2013

(51) Int. Cl. A61H 1/02

(52) U.S. Cl. CPC A61H 1/0218
USPC 482/91

(57) ABSTRACT

Many known portable tissue stretching devices do not properly allow the user to control the treatment intensity because of the need to reposition one's hands on the device when increasing stretch intensity. Some known portable tissue stretching devices are not readily held with two hands due to the small gripping surface. The limitations of these devices often leads to decreased home exercise compliance thereby negatively affecting patient outcomes. Medical professionals have widely accepted the notion that patient compliance with home exercises is poor. A handheld tissue stretching device with left and right handles, a retractor and release mechanism provides numerous benefits, such as improved ease of use and increased home exercise compliance. Individuals now have the option to independently and reliably improve their flexibility with a bilateral grip that does not require changing hand position while stretching.

### BACKGROUND

The present invention relates to extremity tissue treatment. Various medical professionals are trained to evaluate and treat a wide variety of musculoskeletal conditions including muscle strain, joint sprain as well as insidious onset of spine and extremity pain. Extremity treatment provided by specialists often includes passive stretching, massage and strengthening exercises. Home-based treatments including stretching are prescribed by medical professionals to reduce patients' long term pain and improve function. Passive stretching by medical professionals is a common treatment to increase extremity flexibility and relieve lower back pain, patellofemoral syndrome, nerve entrapment, sciatica, plantar fasciitis, achilles tendon tightness, and various tendonopathies. Treatment regimens include a stretch intensity, duration, and frequency for each exercise. Patients perform prescribed treatments at home by using a towel, belt, or a strap such as the “stretch-out-strap” by OPTP products. Stretching to increase extremity tissue length and flexibility is referred to as “treatment”.

At home, many patients have difficulty performing and complying with the prescribed treatment regimen. Many patients lack the necessary upper extremity coordination and grip strength to execute needed techniques with current handheld stretching devices. These devices often require repositioning of the hands in between stretches and sufficient grip and upper extremity strength to maintain a consistent stretch throughout the duration of the treatment. When home based treatments are difficult, patient compliance decreases and tissue stiffness increases thereby reducing muscle-sinew tissue compliance, noted as the degree to which the muscle-sinew tissue complies to treatment. This decrease in muscle-sinew tissue compliance often leaves patients wondering what treatment regimen to follow to achieve acceptable flexibility. To determine the new treatment regimen, patients return to the clinic, have a physical therapist evaluate their tissue flexibility using a goniometer and prescribe a modification to the treatment regimen. This can be a costly, time consuming, and often painful approach to maintaining optimal flexibility.

### SUMMARY

Many known portable tissue stretching devices do not properly allow the user to control the treatment intensity because of the need to reposition one's hands on the device when increasing stretch intensity. Some known portable tissue stretching devices are not readily held with two hands due to the small gripping surface. The limitations of these devices often leads to decreased home exercise compliance thereby negatively affecting patient outcomes. Medical professionals have widely accepted the notion that patient compliance with home exercises is poor. A handheld tissue stretching device with left and right handles, a retractor and release mechanism provides numerous benefits, such as improved ease of use and increased home exercise compliance. Individuals now have the option to independently and reliably improve their flexibility with a bilateral grip that does not require changing hand position while stretching.

In accordance with the invention, a handheld tissue stretching device, combined with a retractor that bisects the housing, a slot in the housing and a pliable, inelastic link allowed to pass through the housing creating left and right handles, minimizes the upper extremity strength and coordination needed to perform home based stretching and enables users to reliably and independently treat the inflexibility of their extremity tissue; thereby, minimizing treatment by a medical professional. The present inventors have recognized that combining a handheld tissue stretching device with a retractor provides users with a repeatable and reliable method for stretching tissue and improved ease of use while stretching.

Medical professionals carefully monitor treatment intensity by verbal, visual and manual inspections to provide a consistent treatment. Outside of the clinic however, handheld passive stretching devices cannot provide users with a reliable and consistent treatment. The known treatment devices have an extremity support, to engage the extremity to be treated and a link between the extremity and the user's hands. The user changes the intensity of the stretch by pulling the extremity support. Pulling the extremity increases muscle-sinew tissue length of the tissue being treated. The user has to reposition his hands on the device or move his hands relative to the extremity support to change stretch intensity. This repositioning imparts a high degree of intensity variability during treatment is leading to inconsistent tissue treatment resulting in increased tissue stiffness. The present inventors have discovered a way to increase stretch intensity consistency during self-treatment of muscle-sinew tissue. When a user increases the stretch intensity, the slack in the pliable, inelastic link, caused by pulling the extremity, is synchronously retracted by a retractor, and the distance between the users hands and the extremity support is continuously proportional to the tissue length of the extremity. This “distance matching” between the handheld stretching device and the extremity support provides a reliable, repeatable, and independent treatment method of extremity inflexibility. This method of treatment ensures a consistent and purposeful treatment regimen.

This handheld tissue treatment apparatus with a retractor and release mechanism treats lower extremities encompassing all tissue emanating from the lower back and terminating at the phalanges. The apparatus may also treat upper extremities encompassing all tissue emanating from the scapula and terminating at the phalanges.

### BRIEF DESCRIPTION OF THE DRAWINGS

FIG. 1 depicts prior art showing a medical professional assisting a patient to treat muscle tissue using an assisted straight leg stretch. The patient is using an inelastic adjustable strap placed on the foot and the medical professional provides overpressure and feedback to maintain knee extension while assisting with hip flexion.

FIG. 2 depicts one embodiment of the present invention, a handheld tissue stretching device with a housing, containing a retractor, bisected by a pliable, inelastic link, a release mechanism, and an extremity support that can be releasably engaged with the user's extremity. The pliable, inelastic link is directly connected to both the retractor at the proximal end and the extremity support at the distal end and prevents the extremity support from extending away from the handheld tissue stretching device when providing treatment.

FIG. 3 depicts one embodiment of the present invention, a retractor is used to remove the slack in the pliable, inelastic link when the extremity support is pulled toward the handheld tissue stretching device. The retractor prevents the extremity support from extending away from the handheld tissue stretching device when providing treatment.

FIG. 4 depicts one embodiment of the present invention. The user is treating tissue by pulling the lower extremity from a first position to a second position to impart a passive stretch on the posterior lower extremity tissue. The extremity support is synchronously retracted towards the housing via a pliable, inelastic link.

FIG. 5 depicts a tubular housing with bisected by a slot, allowing the pliable, inelastic link to pass through the housing, creating left and right handles.

### DETAILED DESCRIPTION

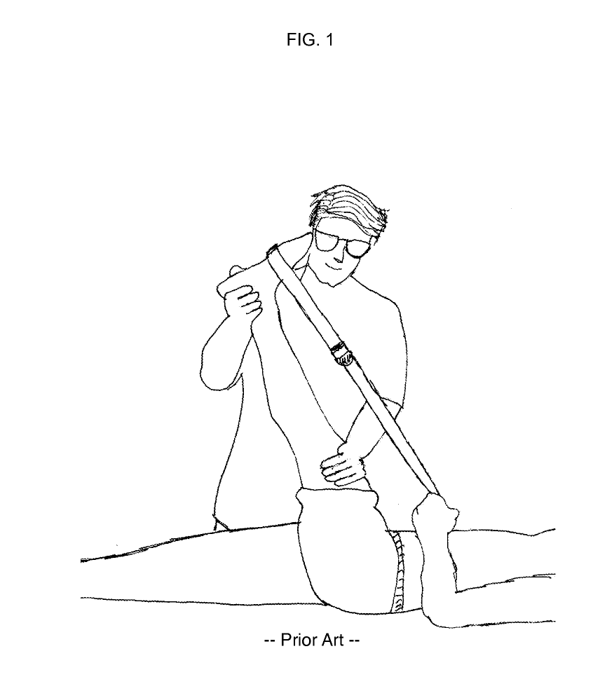

Jordan US 2006/0201450 teaches stretching the lower extremity with a retractable dog leash. The retractor allows the extremity support to move towards and away the handle freely. The locking mechanism prohibits the strap from retracting or protracting from the handle. The handle on the housing is shown to be used with one hand in FIG. 1 of said Jordan patent application. The retractor in this apparatus does not provide enough pulling force to assist the user when performing the straight leg passive stretch. The pulling force is less than 1 pound-force.

Flynn US 2010/0016132 teaches a modular apparatus for performing strengthening and stretching exercises including a housing connected to a nonelastic strap which is subsequently attached to an elastic resistance band. This apparatus allows the extremity of the user to move to and from the handle section of the modular apparatus when it is locked due to the elasticity of the resistance band. This apparatus requires repositioning of the hands because the elastic resistance band allows the user's extremity to be extended away from the users hands.

Many known portable tissue stretching devices do not properly allow the user to control the treatment intensity because of the need to reposition one's hands on the device when increasing stretch intensity. Some known portable tissue stretching devices are not readily held with two hands due to the small gripping surface. A handheld tissue stretching device with left and right handles, a retractor and release mechanism provides numerous benefits, as detailed hereinabove. Individuals now have the option to independently and reliably improve their flexibility with a bilateral grip that does not require changing hand position while stretching.

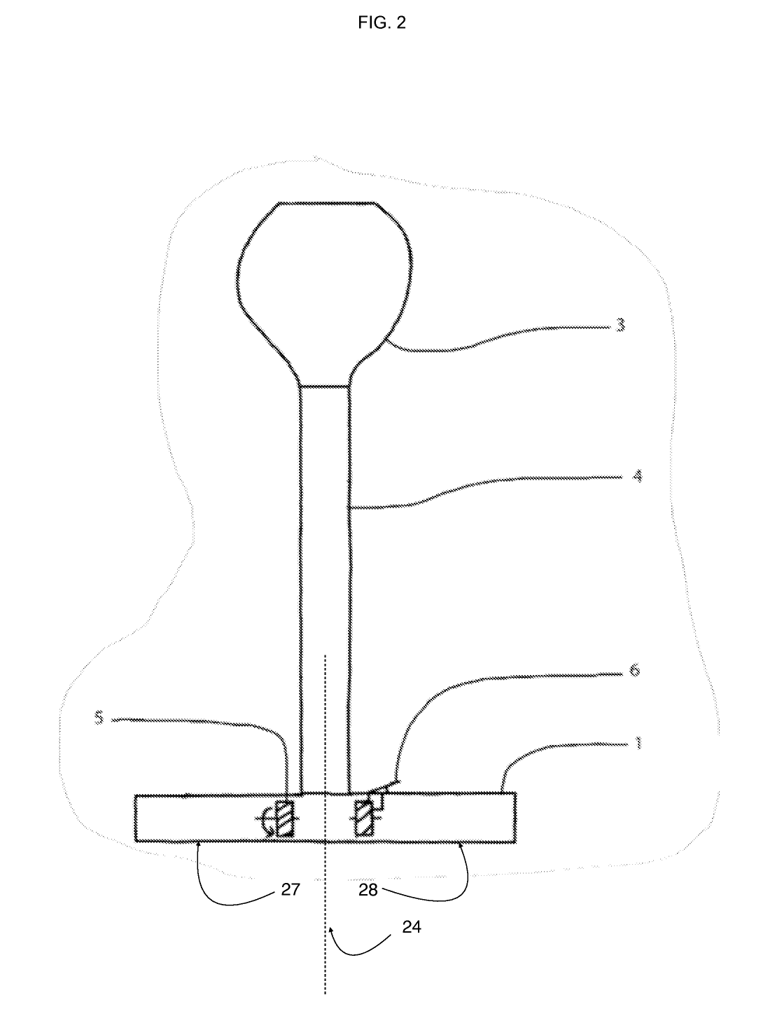

In accordance with the invention, FIG. 2 depicts one embodiment of the invention, a handheld tissue stretching device that an individual may use for treating extremity inflexibility without involving another person. This device has a housing 1 containing a retractor 5 that bisects 24 the housing 1 creating a left 27 and right 28 handle of the housing 1, an extremity support 3 that may be releasably engaged to the user's extremity for treatment. The extremity support 3 is directly connected to the housing 1 via a pliable, inelastic link 4 at the distal end. A retractor 5, directly connected to the proximal end of the pliable inelastic link, retracts the pliable inelastic link 4 and pulls the extremity support 3 toward the housing 1. The pliable, inelastic link 4 and retractor 5 prevent the extremity support from extending away from the housing 1. A release mechanism 6 is used to disengage the retractor 5 and allow the user to extend the extremity support 3 away from the housing 1. This device enables users to treat the inflexibility of their extremity tissue as needed, minimizing physical therapist intervention to prescribe a treatment regimen. Until now, compliance with home exercise treatment regimens has been relatively low due in large part to the difficulty performing the stretches. The present inventors have recognized that a handheld tissue stretching device with a retractor 5 and a release mechanism 6 provides a consistent retracting force and decreases the need for upper extremity coordination and strength to perform the stretch.

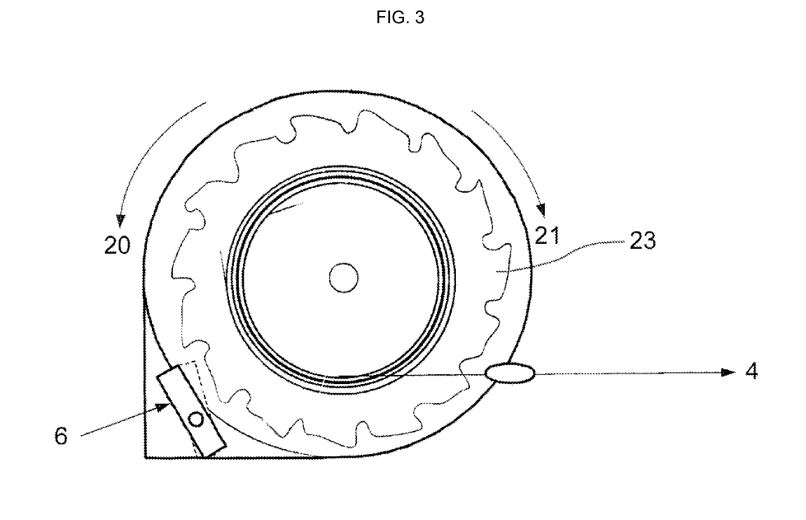

FIG. 3 shows one embodiment of a retractor 5. The extremity support 3 is pulled toward 21 the housing 1. A release mechanism 6 when engaged with the retractor gear 23 prevents the extremity support 3 from protracting from 20 the handheld tissue stretching device. The retractor pulling force ranges from about 1 pounds force to about 20 pounds force. The release mechanism 6, when disengaged with the retractor gear 23 allows the extremity support 3 to be protracted 20 from the housing 1. When the release mechanism 6 is not being activated by the user, the retractor 5 operates in one-direction 21 only. The release mechanism 6 is normally engaged with the retractor gear 23 allowing only retraction 21 of said pliable inelastic link 4.

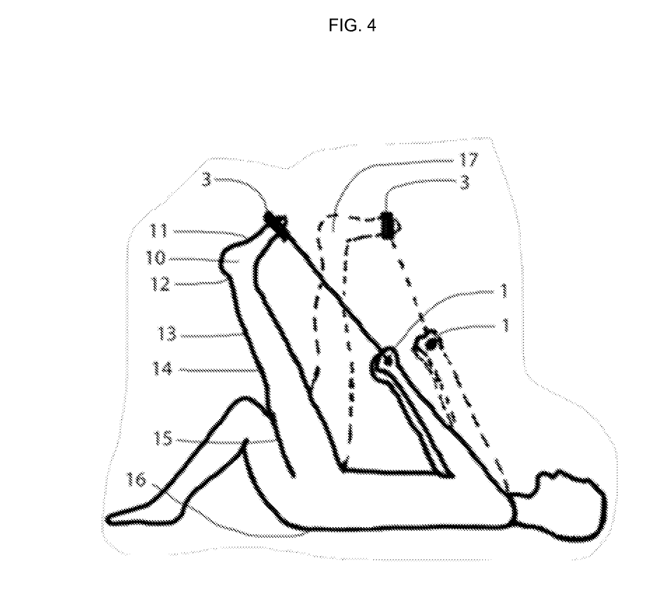

FIG. 4 shows a particular method employing one embodiment of the invention, a user stretching the posterior lower extremity. The user holds the housing 1 in his hands and engages the extremity support 3 on the metatarsal foot pad in a relaxed position 10. The user then increases the intensity of the stretch actively raising his extremity and simultaneously pulling on the housing 1 and the retractor 5 assists in pulling the extremity support 3 toward the housing 1 and retracts the pliable, inelastic link 4 as the tissue being treated is lengthened. The plantar fascia tissue 11, the achilles tendon 12, the calf musculature 13, the popliteal fossa 14, the hamstring muscle group 15, and the lower back muscles and sinew 16 begin to lengthen as the user pulls the extremity to the second position 17. A shorter distance between the extremity support 3 and the housing 1 corresponds directly to lengthening the tissue of the posterior lower extremity: plantar fascia tissue 11, the achilles tendon 12, the calf musculature 13, the popliteal fossa 14, the hamstring muscle group 15, and the lower back 16. The user may disengage the release mechanism 6 from the retractor gear 23 to protract 20 the extremity support 3 away from the housing 1 and allow the user to lower the lower extremity to the support surface.

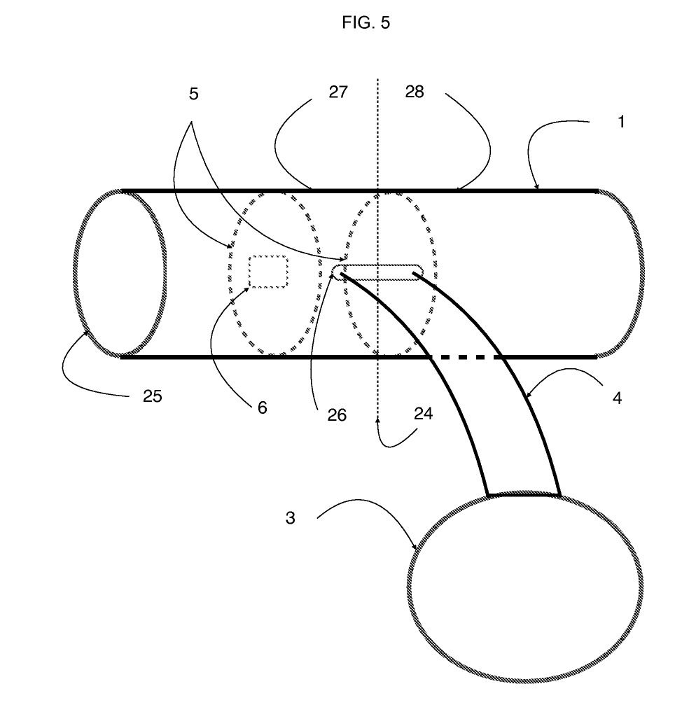

FIG. 5 shows one embodiment of the invention. The retractor 5 detailed in FIG. 3 is positioned within the tubular 25 housing 1 and bisects 24 the housing 1. A slot 26 is positioned to bisect 24 the housing 1 where the pliable, inelastic link 4 is allowed to pass through the slot 26 in the housing 1. The pliable inelastic link 4 passes through the housing 1 creating left 27 and right 28 handles. The user must separate his or her hands on housing 1 because the pliable, inelastic link 4 bisects the housing 1 creating left 27 and right 28 handles. The extremity support 3 is directly connected to the pliable, inelastic link 4.

Treatment is performed when the user's extremity is engaged with the extremity support 3 of the handheld tissue stretching device. A pliable, inelastic link 4 is used to directly connect the extremity support 3 to the retractor 5. The housing 1 has a retractor 5 that retracts 21 the pliable, inelastic link 4 as the extremity support 3 moves toward the housing 1. Minimizing this distance enables users to eliminate continuous and variable hand re-positioning on the housing 1 in order to change the intensity of the inflexibility treatment. This “distance matching” between the housing 1 and the extremity support 3 provides a reliable, repeatable, and independent treatment of extremity tissue inflexibility.

In a particular embodiment of the invention, the user improves the extremity flexibility when performing a passive stretch 17 on the lower posterior tissue by bending the contralateral lower extremity. The present inventors have shown immediate improvements in the ease of performing the stretch explained by bending the contralateral extremity. This bending of the contralateral extremity allows the extremity being stretched to become more perpendicular to the support surface. When the ipsilateral extremity becomes more perpendicular to the floor, the pulling force required between the housing 1 and the extremity support 3 is reduced because the downward component of the weight does not have to be overcome by the pulling force. Reducing the pulling force using this method enables users to maintain stretch intensity and requires less upper body and hand strength. A stretching method requiring less grip strength is desirable for persons with upper extremity weakness and coordination deficits. In addition, a retractor with a pulling force greater than 1 pound-force will help assist the user when performing stretches.

This handheld human tissue stretching apparatus with a retractor and release mechanism treats lower extremities encompassing all tissue emanating from the lower back and terminating at the phalanges. The apparatus may also treat upper extremities encompassing all tissue emanating from the scapula and terminating at the phalanges.

We claim:

1. A human tissue stretching apparatus, apparatus comprising
a first end, wherein said first end comprises a housing with a retractor that is directly attached to a pliable, inelastic link that exits the housing through a slot that bisects the housing into left and right handles,
a second end, wherein said second end comprises an extremity support, capable of releasably engaging a human extremity, directly attached to said pliable inelastic link, and
a release mechanism, wherein said release mechanism disengages said retractor allowing said second end to be protracted from said first end.

2. Apparatus of claim 1, wherein said housing is tubular.

3. Apparatus of claim 1, wherein said release mechanism is normally engaged with said retractor allowing only retraction of said pliable inelastic link.

4. Apparatus of claim 1, wherein said retractor has a pulling force greater than 1 pound-force.

5. A handheld tissue stretching apparatus, apparatus comprising
a first end, wherein said first end comprises a tubular housing, a retractor, a slot and a pliable inelastic link, wherein said pliable inelastic link directly connects to said retractor and passes through said slot creating left and right handles,
a second end, wherein said second end comprises an extremity support, capable of releasably engaging a user's extremity, directly attached to said pliable inelastic link, and
a release mechanism, wherein said release mechanism disengages said retractor enabling said extremity support to be protracted from said left and right handles.

6. A method for treating extremity tissue inflexibility using a tubular handheld tissue stretching apparatus with left and right handles and a retractor directly connected to an extremity support via a pliable inelastic link, method comprising,
holding said left and right handles,
engaging extremity to be treated to said extremity support,
pulling said extremity support toward said handles,
moving said tubular housing toward said extremity support, synchronously retracting said pliable, inelastic link.
